(19) United States
(12) Patent Application Publication
(10) Pub. No.: US 2002/0006500 A1
(43) Pub. Date: Jan. 17, 2002

(54) Rewritable thermosensible recording medium and producing method thereof

(75) Inventors: Hideaki Ueda, Kishiwada-Shi (JP); Naoya Suzuki, Takatsuki-Shi (JP)

Correspondence Address: SIDLEY AUSTIN BROWN & WOOD, 717 NORTH HARWOOD, SUITE 3400, DALLAS, TX, 75201, US

(73) Assignee: Minolta Co., Ltd

(21) Appl. No.: 09/879,512

(22) Filed: Jun. 12, 2001

(30) Foreign Application Priority Data
Jun. 16, 2000 (JP) 2000-181795

(51) Int. Cl. B41M 5/26

(52) U.S. Cl. 428/195

(57) ABSTRACT

A rewritable thermosensible recording medium which has a base film of a polymeric material, an intermediate layer if necessary, a recording layer which contains a liquid crystalline compound and a preventive film of a polymeric material. In order to control the alignment of the liquid crystalline compound, pressure is applied to the liquid crystalline compound contained in the recording layer under heat, and thereby, a shearing stress is applied thereto. Specifically, after structuring the base film, the recording layer and the preventive film into a laminate, a bending treatment is carried out toward the laminate continuously, and thereby a shearing stress is applied to the recording layer.

This application is based on Japanese patent application No. 2000-181795, the contents of which are hereby incorporated by reference.

### BACKGROUND OF THE INVENTION

1. Field of the Invention

The present invention relates to a rewritable thermosensible recording medium and a producing method thereof, and more particularly to a rewritable thermosensible recording medium which information can be written on and erased from under specified temperatures and a producing method of the recording medium.

2. Description of Related Art

Recently, while resource saving and recycling are great concerns, it is demanded that recording media such as paper are usable repeatedly. In developing such recording media, rewritable thermosensible materials which information can be written on and erased from by use of heating means such as a thermal head attract attention. Such rewritable thermosensible materials are not only useful for recycling of recording media but also usable to visualize information stored in IC cards, magnetic cards, optical cards, etc, and thus, various applications of such rewritable thermosensible materials are possible.

As these rewritable thermosensible materials, conventionally, leuco dyes with a developer and a subtractive agent, organic low molecular weight liquid crystal dispersed in high molecular weight resin, polymer cholesteric liquid crystal are well known.

A leuco dye with a developer and a subtractive agent develops a color as the lactone rings contained in the leuco dye molecules open, and loses the color as the lactone rings close. The lactone rings open when they are heated and thereafter cooled rapidly, and close when they are heated and thereafter cooled gradually. Such a leuco dye with a developer and a subtractive agent is coated on a sheet member. Then, information is written thereon with a thermal head, and the information is erased therefrom with heat rollers.

A well-known type of organic low molecular liquid crystal dispersed in high molecular weight resin uses BA (behenic acid) as the organic low molecular weight compound and uses PVCA (polyvinylchloride polyvinyl acetate copolymer) as the high molecular weight compound. This material can be switched between a transmitting state and a scattering state in accordance with the heating temperature and can maintain the state after being cooled. This material is coated on a sheet member, and information is written thereon with a thermal head.

As polymer liquid crystal, a polymer of a vinyl compound having a cholesteric liquid crystalline compound as a side chain is well known. This material can be caused to change the display color and maintain the color by being heated beyond the crystallization temperature and thereafter being cooled rapidly from a specified temperature.

Advanced Material, 9(14), 1102-1104(1997) disclosed some kinds of low molecular weight and intermediate molecular weight cholesteric liquid crystal which are rewritable and thermosensible. Such materials can be caused to change the display color and maintain the color by being heated beyond the crystallization temperature and thereafter being cooloed rapidly from a specified temperature.

With respect to the leuco dyes with a developer and a subtractive agent, the displayable colors depend on the leuco dye, and it is impossible to display any desired image in full color. With respect to the organic low molecular weight liquid crystal dispersed in high molecular weight resin, since it makes a display by switching between a transmitting state and a scattering state, full-color display is impossible.

Polymer liquid crystal, low molecular weight cholesteric liquid crystal and intermediate molecular weight cholesteric liquid crystal have problems in production conditions and materials, and practical usage of these materials is impossible for now.

### SUMMARY OF THE INVENTION

An object of the present invention is to provide a rewritable thermosensible recording medium which is capable of making color display with the displayed colors dense, of which initial control is easy and which is capable of reproducing information thereon accurately with little color unevenness, and a method of producing such a rewritable thermosensible recording medium.

Further, another object of the present invention is to provide a method for producing a thermosensible recording medium with the above-described advantages at low cost.

In order to attain the objects above, a rewritable thermosensible recording medium according to the present invention comprises: a base film of a polymeric material; a recording layer which contains a liquid crystalline compound; and a preventive film of a polymeric material, and the liquid crystalline compound contained in the recording layer has alignment which is controlled by application of a shearing stress which is attained by application of pressure under heat.

In the rewritable thermosensible recording medium according to the present invention, pressure is applied to the liquid crystalline compound contained in the recording layer under heat, and thereby, a shearing stress is applied to the liquid crystalline compound. Thus, the alignment of the liquid crystalline compound is controlled. Therefore, the recording medium has the following advantages: color unevenness is hardly seen; the density of displayed colors is high; and the control of the initial state after erasing of an image therefrom is easy.

According to the present invention, a liquid crystalline compound which exhibits a cholesteric phase is suited to be used as the liquid crystalline compound contained in the recording layer. Any liquid crystalline compound of this kind, whether it is a high molecular weight compound or a low molecular weight compound, is usable; however, a low or an intermediate molecular weight compound is better because the writing speed is higher.

The rewritable thermosensible recording medium according to the present invention may have recording layers both on the upper surface and on the lower surface of the base film. By providing recording layers on the both surfaces of the base film, information can be written on both surfaces of the recording medium. Also, the recording medium may be of a structure which has two or more recording layers laminated together.

The rewritable thermosensible recording medium according to the present invention may further comprise an intermediate layer between the base film and the recording layer, and the intermediate layer has a smooth surface which is in contact with the recording layer. When liquid crystal exhibits a cholesteric phase, in order to align the helical axis in a direction perpendicular to the base film, it is preferred that the surface of the base film is substantially smooth. If the intermediate layer is provided between the base film and the recording layer, even a rough material can be used for the base film. Further, because of the intermediate layer, the helical axis of liquid crystal can be well aligned in the direction perpendicular to the base film, and a display with high reflectance becomes possible.

Further, the recording layer of the rewritable thermosensible recording medium according to the present invention may be a composite layer of a liquid crystalline compound and polymeric resin. By forming a recording layer of such a composite layer, the recording layer obtains a high mechanical strength, and the recording medium becomes strong against bends and frictions. The recording layer may further contain spacers of a specified shape. By the spacers, the thickness of the recording layer can be uniformed, and when a heat roller applied pressure to the recording medium for erasure of information from the recording medium, the thickness of the recording layer can be kept.

A method for producing a rewritable thermosensible recording medium according to the present invention comprises the steps of: placing a recording layer containing a liquid crystalline compound and a preventive film of a polymeric material on a base film of a polymeric material to structure these films and layer into a laminate; and applying a shearing stress to the recording layer by applying pressure under heat.

In the method according to the present invention, pressure is applied to the recording layer under heat, and thereby, a shearing stress is applied thereto. In this way, the alignment of the liquid crystalline compound contained in the recording layer is controlled. Thus, a rewritable thermosensible recording medium which hardly has color unevenness, which has a high density of display colors and of which initial control is easy can be produced.

In the method, a preferable way of applying a shearing stress to the recording layer is carrying out a bending treatment toward the laminate of the base film, the recording layer and the preventive film. The bending treatment can be carried out by use of at least one freely rotating roller, or a shearing stress is applied to the laminate while the laminate is passing between at least two freely rotating rollers. In this way, a rewritable thermosensible recording medium can be produced in simple facilities and at low cost.

If long films are used for the base film and/or the preventive film, such rewritable thermosensible recording media can be manufactured successively and efficiently. The long films shall be cut after being laminated and supplied with a shearing stress.

### BRIEF DESCRIPTION OF THE DRAWINGS

These and other objects and features of the present invention will be apparent from the following description with reference to the accompanying drawings, in which:

FIG. 1 is a sectional view of a first embodiment of a recording medium according to the present invention;

FIG. 2 is a sectional view of a second embodiment of a recording medium according to the present invention;

FIG. 3 is a sectional view of a third embodiment of a recording medium according to the present invention;

FIG. 4 is a sectional view of a fourth embodiment of a recording medium according to the present invention;

FIG. 5 is a sectional view of a fifth embodiment of a recording medium according to the present invention;

FIG. 6 is a sectional view of a sixth embodiment of a recording medium according to the present invention;

FIG. 7 is a sectional view of a seventh embodiment of a recording medium according to the present invention;

FIG. 8 is a schematic view of a manufacturing apparatus for producing recording media according to the present invention;

FIG. 9 is a schematic view of a modified part (coating section) of the manufacturing apparatus;

FIG. 10 is a schematic view of a modified part (tension applying section) of the manufacturing apparatus;

FIG. 11 is a schematic view of a modified part (tension applying section) of the manufacturing apparatus;

FIG. 12 is a schematic view of a modified part (tension applying section) of the manufacturing apparatus;

FIG. 13 is a schematic view of a modified part (coating section) of the manufacturing apparatus;

FIG. 14 is a schematic view of a thermal printer;

FIG. 15 is a plan view of a thermal head of the thermal printer; and

FIG. 16 is a schematic perspective view of a laser printer.

### DETAILED DESCRIPTION OF THE PREFERRED EMBODIMENTS

Embodiments of a thermosensible recording medium and a producing method thereof are described with reference to the accompanying drawings. In the embodiments below, specific substances are named; however, these are merely examples, and various other materials can be used.

### First Embodiment of Recording Medium; See FIG. 1

Referring to FIG. 1, a rewritable thermosensible recording medium 1A comprises a base 2, an intermediate layer 3, a recording layer 4 and a protective layer 5. As the base 2, a film of flexible polymeric material, such as polycarbonate, PET (polyethylene terephthalate), etc., is used. By using a flexible film as the base 2, it becomes possible to handle the recording medium 1A like paper. As the protective layer 5, likewise, a film of polymeric material is used. Although FIG. 1 does not show, spacers may be contained in the recording layer 4.

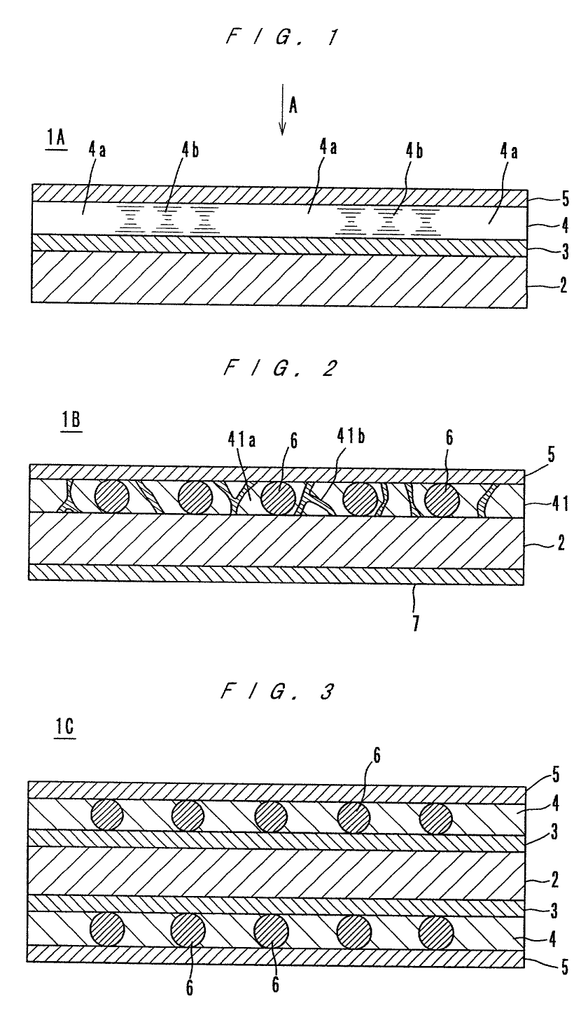

### Second Embodiment of Recording Medium; See FIG. 2

Referring to FIG. 2, a rewritable thermosensible recording medium 1B comprises a base 2, a recording layer 41, a protective layer 5 and a light absorbing layer 7 which is provided on the back side of the base 2. The recording layer 41 comprises spherical spacers 6 made of resin, inorganic oxide or the like to keep the thickness.

The recording layer 41 is a polymeric composite layer and divided into liquid crystal portions 41a and resin portions 41b. The usage of the polymeric composite layer heightens the mechanical strength of the recording layer 41, and damage due to external force such as bends, frictions, etc. can be minimized. If the liquid crystal portions 41a are an intermediate molecular weight cholesteric liquid crystalline compound, when the intermediate molecular weight cholesteric liquid crystalline compound is heated to the temperature to come to an isotropic phase, the liquid crystalline compound does not degrade much.

### Third Embodiment of Recording Medium; See FIG. 3

FIG. 3 shows a rewritable thermosensible recording medium 1C. On both sides of a base 2, intermediate layers 3, recording layers 4 and protective layers 5 are provided. The recording layers 4 comprise spacers 6 to regulate the thickness.

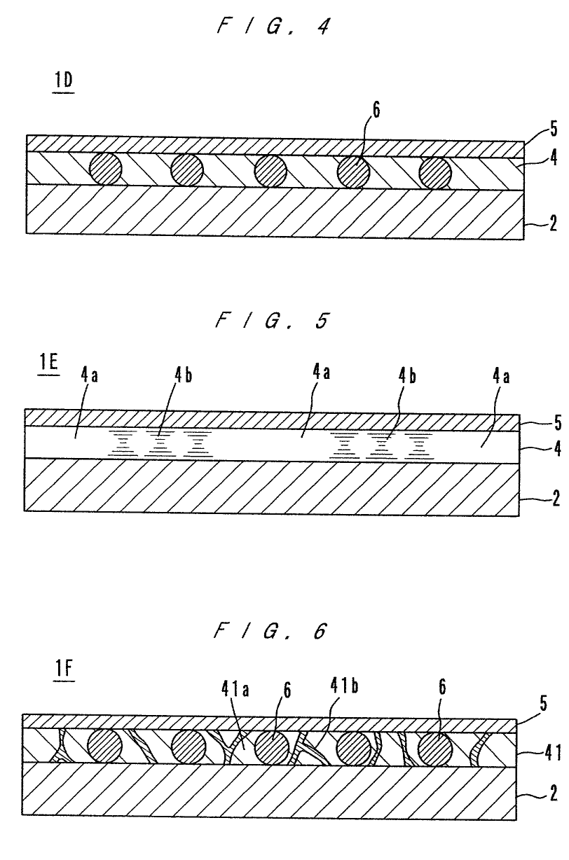

### Fourth Embodiment of Recording Medium; See FIG. 4

Referring to FIG. 4, a rewritable thermosensible recording medium 1D comprises a base 2, a recording layer 4 and a protective layer 5. The recording layer 4 comprises spacers 6 to regulate the thickness. The base 2 also functions as a light absorber.

### Fifth Embodiment of Recording Medium; See FIG. 5

Referring to FIG. 5, a rewritable thermosensible recording medium 1E comprises a base 2, a recording layer 4 and a protective layer 5. Spacers are omitted from the recording layer 4. As in the fourth embodiment, the base 2 has a light absorbing function.

### Sixth Embodiment of Recording Medium; See FIG. 6

Referring to FIG. 6, a rewritable thermosensible recording medium 1F comprises a base 2, a recording layer 41 and a protective layer 5. The recording layer 41 comprises spherical spacers 6 made of resin, inorganic oxide or the like to keep the thickness.

As in the second embodiment, the recording layer 41 is a polymeric composite layer which comprises liquid crystal portions 41a and resin portions 41b. The base 2 has a light absorbing function.

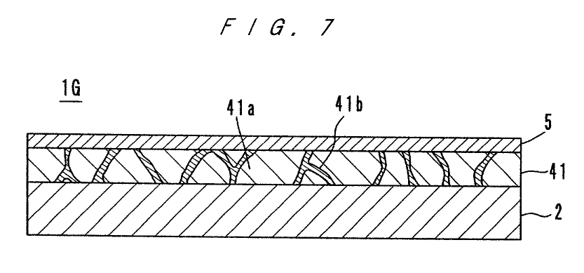

### Seventh Embodiment of Recording Medium; See FIG. 7

Referring to FIG. 7, a rewritable thermosensible recording medium 1G comprises a base 2, a recording layer 41 and a protective layer 5. Spacers are omitted from the recording layer 41. The base 2 has a light absorbing function. As in the second and sixth embodiments, the recording layer 41 is a polymeric composite layer which comprises liquid crystal portions 41a and resin portions 41b.

### Liquid Crystalline Compounds

The following chemical formulas (A) through (G) show exemplary low molecule weight and intermediate molecule weight cholesteric liquid crystalline compounds which are usable for the recording layer 4 in the respective embodiments.

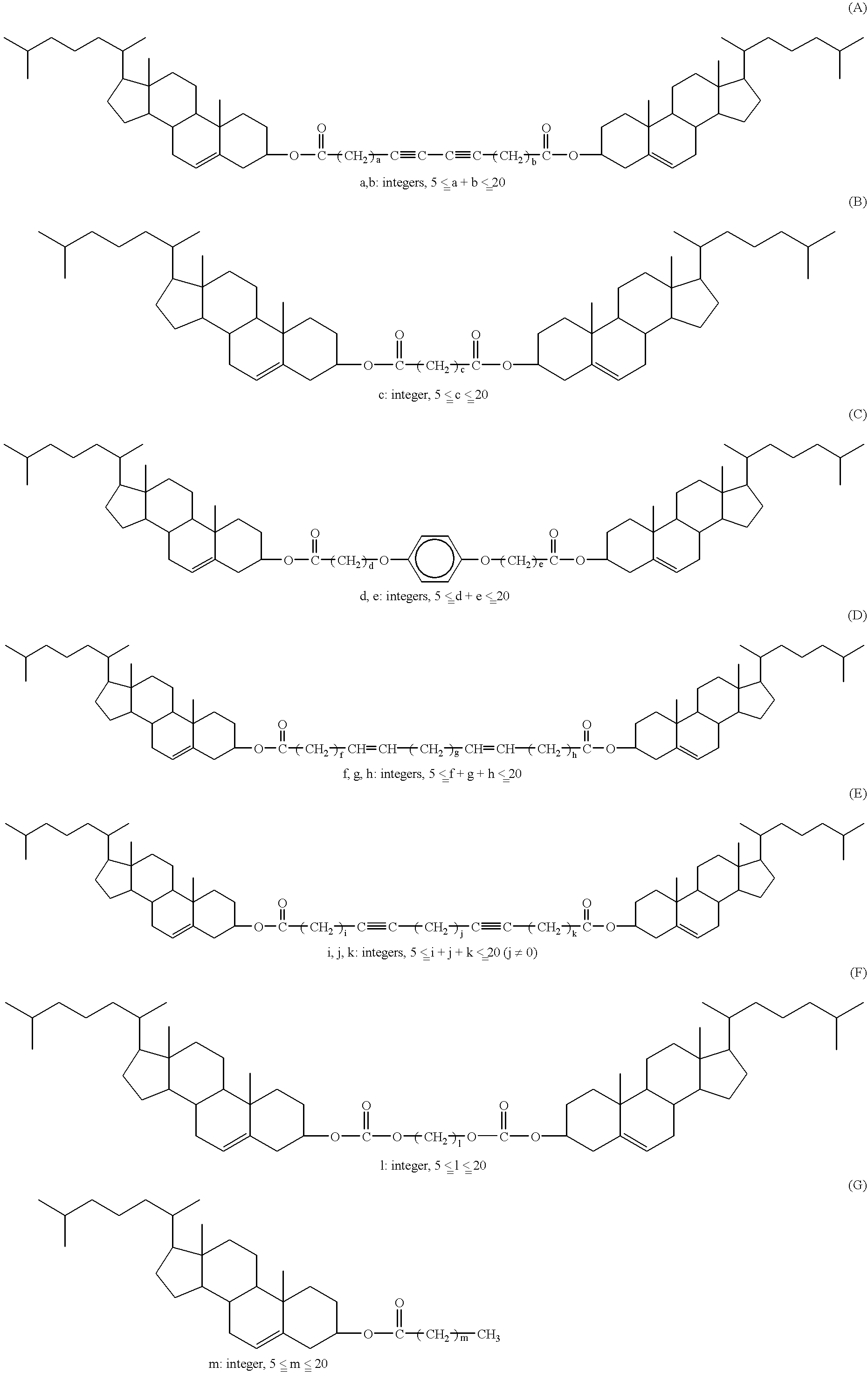

A plurality of compounds selecting from the compounds expressed by the above formulas can be used in combination. For example, compounds which are of the same generic formula and have different alkyl chain lengths may be combined, or low molecule weight and intermediate molecule weight cholesteric liquid crystalline compounds which are of different generic formulas may be combined.

Other than the compounds expressed by the above formulas, various low molecule weight and intermediate molecule weight compounds are usable. For example, a polymer of a vinyl compound with a cholesteric liquid crystalline compound as a side chain and polymer choelsteric liquid crystal which is produced by mixing polymer nematic liquid crystalline compound with a vinyl compound with a chiral component as a side chain are usable.

Preferably, the recording layer 4 contains at least one kind of low molecular weight or intermediate molecular weight cholesteric liquid crystalline compound which has a molecular weight of 1000 to 2000. If the molecular weight of the recording layer 4 is under 1000, the recording layer 4 cannot attain a sufficiently high memory effect. If the molecular weight of the recording layer is over 2000, the responsibility to writing becomes low, and/or the transition temperature to a cholesteric phase becomes too high.

### First Example of Recording Medium; See FIGS. 1 and 8

A specific example of the rewritable thermosensible recording medium 1A shown by FIG. 1 is described referring to a producing method thereof. The recording medium 1A was produced by use of a manufacturing apparatus 100 shown by FIG. 8.

A roll of a long polymeric film 2a was set in a feed roll 110 as the material of the base 2, and the film 2a was rewound by rotation of a roller 111. In this example, a PET (polyethylene terephthalate) film with a thickness of 100 μm was used. On the PET film 2a, thermosetting urethane resin with carbon black dispersed therein was coated with a thickness of 20 μm and hardened into the intermediate layer (light absorbing layer) 3.

A liquid crystal composition for the recording layer 4 contained an intermediate molecular weight cholesteric liquid crystalline compound. Specifically, a liquid crystalline compound expressed by the following chemical formula (A₁) and a liquid crystalline compound expressed by the following chemical formula (B₁) were mixed with each other at the ratio by weight of 1:1, and spacer particles with an average diameter of 10 μm were added to this mixture.

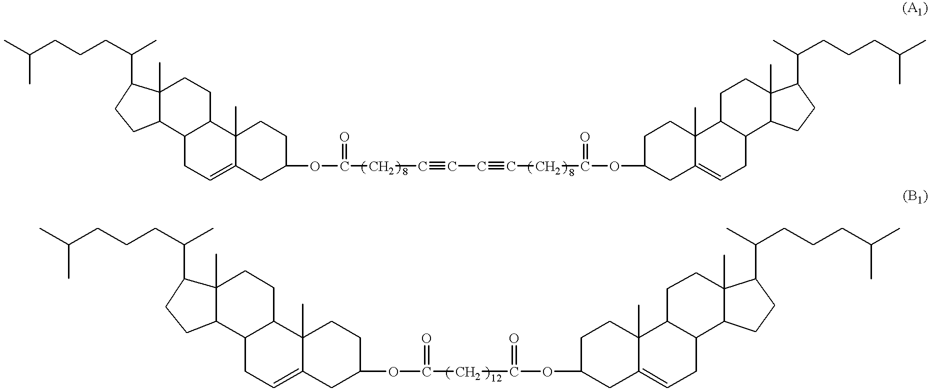

The liquid crystal composition was coated on the intermediate layer 3 on the base film 2a by use of a coating device 112. The coating device 112 comprises a dispenser section 113, a coating roll 114 and a heating oven 115. The liquid crystal composition was filled in the dispenser section 113. Then, the dispenser section 113 was heated, and thereby, the liquid crystal in the dispenser section 113 came to an isotropic phase. In this state, the liquid crystal composition was coated on the base film 2a by the coating roll 114. At this time, the liquid crystal composition was heated by the heating oven 115, so that the base film 2a was fed in the direction of arrow “a” with the liquid crystal composition coated thereon keeping the thickness constantly.

A roll of a long polymeric film 5a was set in another feed roll 120 as the material of the preventive layer 5, and the film 5a was rewound in the direction of arrow “b” by rotation of a roller 121. In this example, a PET film with a thickness of 6 μm was used.

The base film 2a with the liquid crystal composition coated thereon and the protective film 5a were heated and pressed against each other between a heat roller 131 and a nip roller 132 and were bonded into a laminate. Thereafter, freely rotating tension rollers 133 and 144 which were located immediately downstream of the rollers 131 and 132 applied a shearing stress to the laminate which was being heated, and thus, an alignment treatment was carried out.

The rotary shafts of the tension rollers 133 and 134 are located in offset positions with respect to the feeding direction. A slight difference was caused between the speed to feed the film 2a and the speed to feed the film 5a, and the laminate was subjected to a bending/deforming treatment continuously, so that a shearing stress was applied to the recording layer 4.

Thereafter, the laminate was cooled and cut by a cutter 136 into pieces with specified dimensions. The sides of each piece were sealed by UV setting resin. In this way, a sheet-like rewritable thermosensible recording medium 1A which had a recording layer 4 with a thickness of 10 μm was produced.

The recording layer 4 desirably has a thickness within a range from 1 μm to 50 μm, and more desirably within a range from 2 μm to 30 μm. The thicker the recording layer 4, the higher the contrast; however, as the thickness of the recording layer 4 is increasing, necessary energy for printing is increasing, and the production cost is increasing. On the other hand, if the recording layer 4 is too thin, the contrast becomes low, and good printing cannot be achieved.

The recording medium 1A of the above-structure is heated to a temperature to come to an isotropic phase and thereafter is cooled rapidly from a temperature within a range from 55° C. to 120° C. Thereby, the liquid crystal composition exhibits a cholesteric phase in which the helical axis is perpendicular to the intermediate layer 3 and selectively reflects light of a specified wavelength according to the temperature. The liquid crystal composition selectively reflects light of red when the temperature is approximately 60° C., selectively reflects light of green when the temperature is approximately 75° C., and selectively reflects light of blue when the temperature is approximately 100° C. Then, when the liquid crystalline compound is cooled rapidly from these temperatures, the liquid crystal composition is solidified keeping the respective reflection states.

Also, when the liquid crystal composition is heated over approximately 120° C. and thereafter cooled rapidly, the liquid crystal composition becomes transparent. Specifically, when the recording medium 1A is heated over 120° C. by a hot plate or the like and thereafter cooled rapidly, the recording layer 4 becomes entirely transparent. In this state, the observer viewing from the direction of arrow “A” sees black because visible light is absorbed by the intermediate layer 3.

By performing heating and rapid cooling toward part of the recording medium 1A by use of a thermal head, the heated part exhibits a color depending on the temperature at which the rapid cooling is started. In FIG. 1, the reference symbol 4a denotes the transparent portions, and the reference symbol 4b denotes the portions which are left in a cholesteric phase. Thus, if writing is performed at 75° C. by a thermal head, viewing from the direction of arrow “A”, a green on black display can be seen. If writing is performed at 60° C., at 75° C. and at 100° C. for writing of R (red), G (green) and B (blue) selectively, a full-color display can be achieved.

In the recording medium 1A, in order to lower the reflectance partly, black portions are mixed in the part.

In this first example, the melting point of the base 2 was not less than 200° C., the melting point of the intermediate layer 3 was not less than 200° C. the crystallization temperature of the protective layer 5 was not less than 200° C., and the melting point of the recording layer 4 was 120° C. Accordingly, when the recording medium 1A is heated to a temperature over 120° C. for writing or for erasing, as long as the temperature is under the melting points of the base 2, the intermediate layer 3 and the protective layer 5, the recording layer 4 is liquefied, while the mechanical strengths of the layers 2, 3 and 5 are not lowered. Thereby, the layers 2, 3 and 5 protect the recording layer 4 against the pressure applied from the thermal head so that the recording layer 4 can keep the thickness. Further, because the recording layer 4 of the recording medium 1A contains spherical spacers, the thickness of the recording layer can be maintained more positively.

In the recording medium 1A, carbon black is contained in the intermediate layer 3, so that the intermediate layer 3 has a function of absorbing light within the entire visible spectrum. However, for example, by imparting the intermediate layer 3 with a function of reflecting light of blue and by performing writing to cause the recording layer 4 to reflect light of yellow, a display with blue and white can be made. Off course, by using this method, a color display can be made. In this method, the reflectance of white portions is the addition of the reflectance of blue light on the intermediate layer 3 and the reflectance of yellow on the recording layer 4. In this case, the reflectance of white portions is larger than the reflectance of white portions which are made by arranging the three primary colors, blue, green and red in mosaic, and a brighter display is possible. Further, by setting the intermediate layer 3 to reflect a plurality of colors, a more colorful display can be made.

The operating temperature range of the recording medium 1A was from 55° C. to 120° C., and within this temperature range, the wavelength of light selectively reflected by the recording medium 1A varied from 680 nm to 400 nm. When writing was performed by a thermal head, the changeable range of reflected colors was wide, and good recording performance was achieved.

The contrast between a green printed portion and a black portion was expressed as the ratio of 7:1 when the Y values (luminous reflectance) of these portions were compared with each other. For this measurement, a reflective type spectral colorimeter CM-3700d (made by Minolta Co., Ltd.), which has a white light source, was used. In the following specific examples and comparative examples, the same spectral colorimeter was used.

### Second Example of Recording Medium; See FIGS. 4, 8 and 9

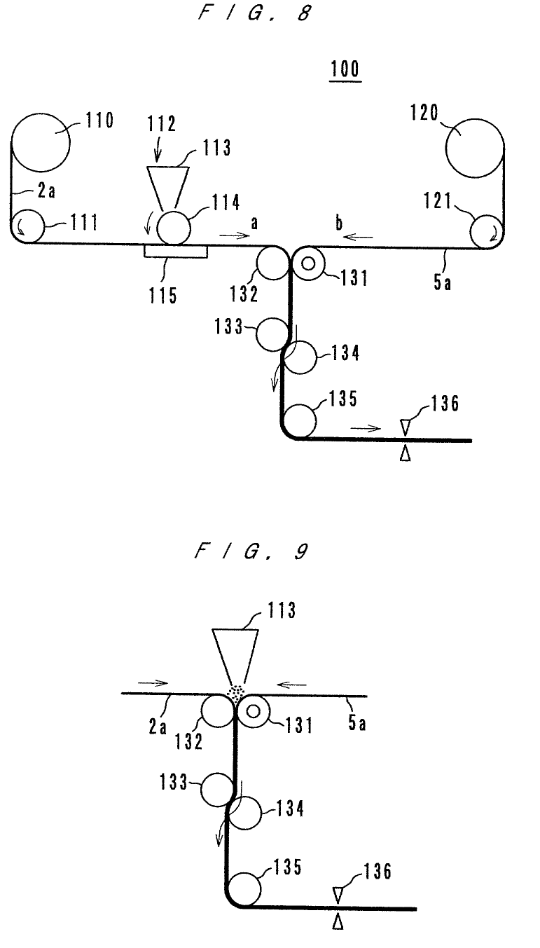

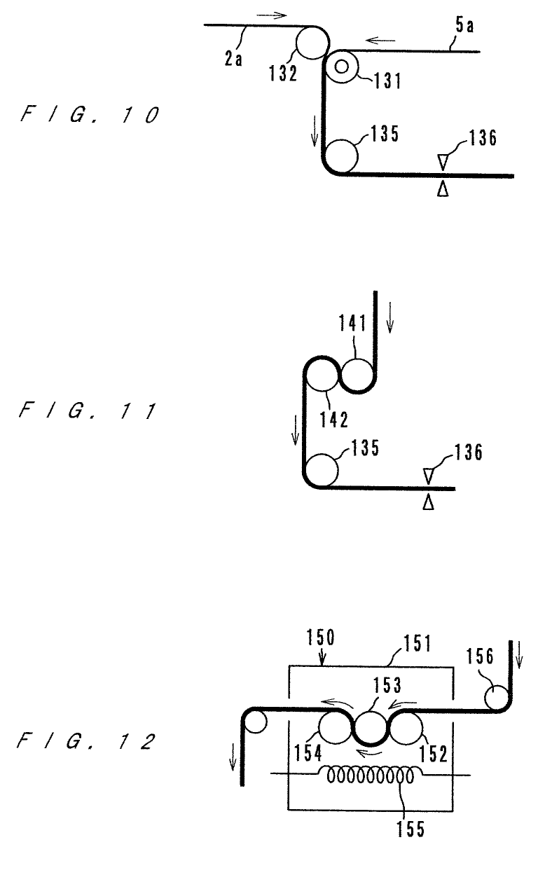

A specific example of the rewritable recording medium 1D shown by FIG. 4 is described referring to a producing method thereof. A manufacturing apparatus which was used to produce this example is basically of the same structure as the apparatus shown by FIG. 8; however, instead of coating a liquid crystal composition on a base film by use of the coating device 112, in this example, as FIG. 9 shows, a liquid crystal composition was directly dispensed from the dispenser section 113 to the nip portion between the heat roller 131 and the nip roller 132.

Specifically, a black PET film (a resin film mixed with carbon black) with a thickness of 200 μm was set in the feed roll 110 as the material of the base film 2a. A transparent PET film with a thickness of 6 μm was set in the feed roll 120 as the material of the preventive film 5a.

A liquid crystal composition 4 for the recording layer 4 contained an intermediate molecular weight cholesterlic liquid crystalline compound. Specifically, liquid crystalline compounds expressed by the chemical formulas (A₁) and (B₁) were mixed with each other at the ratio by weight of 1:1, and spacer particles with an average diameter of 15 μm were added to the mixture.

The liquid crystal composition was filled in the dispenser section 113. Then, the dispenser section 113 was heated until the liquid crystal came to an isotropic phase, and in this state, a specified amount of the liquid crystal composition was dropped onto the films 2a and 5a supported on the rollers 131 and 132. At this time, as FIG. 9 shows, the liquid crystal composition dispensed between the films 2a and 5a was nipped between the heat roller 131 and the nip roller 132 and spread. Thus, the film 2a, the liquid crystal composition and the film 5a were formed into a laminate, and the recording layer 4 was formed.

Thereafter, as in the first example, the freely rotating tension rollers 133 and 132 which were located immediately downstream of the heat roller 131 and the nip roller 132 applied a shearing stress to the laminate which was being heated, and thus, an alignment treatment was carried out. Then, the laminate was cooled and cut by the cutter 136 into pieces with specified dimensions. The sides of each piece were sealed by UV setting resin. Thus, a sheet-like rewritable thermosensible recording medium 1D which had a recording layer 4 with a thickness of 15 μm was produced.

The operating temperature range of the recording medium 1D was from 55° C. to 120° C., and within this temperature range, the wavelength of light selectively reflected by the recording medium 1D varied from 680 nm to 400 nm. When writing was performed by a thermal head, the changeable range of reflected colors was wide, and good recording performance was achieved. The contrast between a green printed portion and a black portion was expressed as the ratio of 7.5:1 when the Y values (luminous reflectance) of these portions were compared with each other.

### Third Example of Recording Medium; See FIGS. 4, 8 and 10

Another specific example of the rewritable thermosensible recording medium 1D is described referring to a producing method thereof. A manufacturing apparatus which was used in this example is basically of the same structure as the apparatus shown by FIG. 8; however, instead of using the tension rollers 133 and 134, as FIG. 10 shows, the heat roller 131 and the freely rotating nip roller 132 were located in offset positions so as to apply a shearing stress.

Specifically, a black PET film (a resin film mixed with carbon black) with a thickness of 150 was set in the feed roll 110 as the material of the base film 2a. A transparent PET film with a thickness of 5 μm was set in the feed roll 120 as the material of the preventive film 5a.

A liquid crystal composition for the recording layer 4 contained an intermediate molecular weight cholesteric liquid crystalline compound. Specifically, the liquid crystalline compound expressed by the chemical formula (A₁) and a liquid crystalline compound expressed by the following chemical formula (B₂) were mixed with each other at the ratio by weight of 1:1, and spacer particles with an average diameter of 10 μm were added to the mixture.

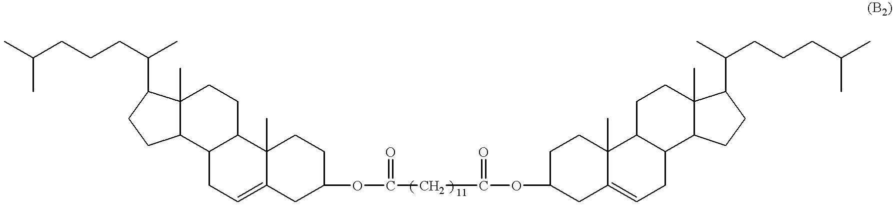

The liquid crystal composition was filled in the dispenser section 113. Then, the dispenser section 113 was heated until the liquid crystal came to an isotropic phase. In this state, the liquid crystal composition was coated on the base film 2a by use of the coating roll 114. At this time, the liquid crystal composition was heated by the heating oven 115 so that the thickness of the liquid crystal composition coated on the base film 2a which was being fed in the direction of arrow “a” could be constant.

As FIG. 10 shows, the base film 2a with the liquid crystal composition coated thereon and the protective film 5a fed from the feed roll 120 joined at a junction between the heat roller 131 and the nip roller 132, where the films 2a and 5a were heated and pressed against each other to turn into a laminate. The rotary shafts of the heat roller 131 and the nip roller 132 were located in offset positions, and the pressing positions of the rollers 131 and 132 were not on a level. Therefore, a shearing stress was applied. Thus, a recording layer 4 was formed, and simultaneously, an alignment treatment was carried out.

Thereafter, the laminate was cooled and cut by the cutter 136 into pieces with specified dimensions, and the sides of each piece were sealed by UV setting resin. Thus, a sheet-like rewritable thermosensible recording medium 1D which had a recording layer 4 with a thickness of 10 μm was produced.

The operating temperature range of the recording medium 1D was from 40° C. to 110° C., and within this temperature range, the wavelength of light selectively reflected by the recording medium 1D varied from 680 nm to 400 nm. When writing was performed by a thermal head, the changeable range of reflected colors was wide, and good recording performance was achieved. The contrast between a green printed portion and a black portion was expressed as the ratio of 6.5:1 when the Y values (luminous reflectance) of these portions were compared with each other.

### Fourth Example of Recording Medium; See FIGS. 4, 6 and 11

Next, a specific example of the rewritable thermosensible recording medium 1F shown by FIG. 6 is described referring to a producing method thereof. The recording layer 41 of the recording medium 1F is a composite layer which is composed of at least two kinds of intermediate molecular weight cholesteric liquid crystalline compounds and polymeric resin.

First, the liquid crystalline compounds expressed by the chemical formulas (A₁) and (B₂) were mixed with each other at the ratio by weight of 1:1, and resin spacer particles with an average diameter of 12 μm were added to the mixture. Further, the mixture and a bifunctional acrylate R712 (made by Nippon Kayaku Co., Ltd.) with an aromatic ring which contains a photopolymerizer DAROCUR1173 (made by Ciba Geigy (Japan) Co., Ltd.) at 3 wt % were mixed with each other at the ratio by weight of 8:2. In this way, a liquid crystal composition was prepared.

Next, on a black PC (polycarbonate) film with a thickness of 200 μm, the liquid crystal composition was coated from a dispenser by use of a coating roll. Then, a transparent polycarbonate film with a thickness of 2 μm was placed on the liquid crystal composition as the preventive layer, and thus, a laminate was structured.

Next, ultraviolet rays of 0.25 mW/cm² were radiated for five minutes, and thereby, a composite layer with a thickness of 12 μm (recording layer 41) was formed.

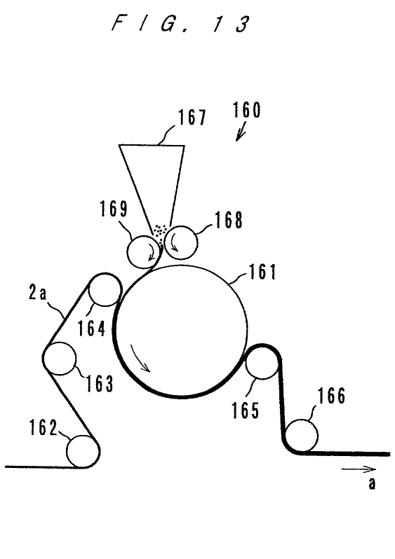

Thereafter, the laminate was transported in the way shown by FIG. 11 between freely rotating tension rollers 141 and 142 which were located in parallel. By applying bends successively to the laminate which was being heated, a shearing stress was applied, and an alignment treatment was carried out. Then, the laminate was cooled and cut by the cutter 136 into pieces with specified dimensions, and the sides of each piece were sealed by UV setting resin. Thus, a sheet-like rewritable thermosensible recording medium 1F which had a recording layer 41 with a thickness of 12 μm was produced.

The operating temperature range of the recording medium 1F was from 40° C. to 110° C., and within this temperature range, the wavelength of light selectively reflected by the recording medium 1D varied from 680 nm to 400 nm. When writing was performed by a thermal head, the changeable range of reflected colors was wide, and good recording performance was achieved. The contrast between a green printed portion and a black portion was expressed as the ratio of 6.5:1 when the Y values (luminous reflectance) of these portions were compared with each other.

### Fifth Embodiment of Recording Medium; See FIGS. 4, 8 and 12

Another example of the rewritable thermosensible recording medium 1D is described referring to a producing method thereof. A manufacturing apparatus which was used in this example is basically of the same structure as the apparatus shown by FIG. 8; however, instead of the tension rollers 133 and 134, a tension applying device 150 shown by FIG. 12 is provided.

The tension applying device 150 comprises freely rotating tension rollers 152, 153, 154 and a heater 155 in a housing 151. The tension applying device 150 receives a laminate which has a recording layer 4 between films 2a and 5a, which is structured by use of the rollers 131 and 132 shown in FIG. 8. The laminate is fed into the housing 151 by a roller 156 and passes between the tension rollers 152, 153 and 154 while being pressed. In this way, the laminate is subjected to bends successively while being heated by a heater 155, and thereby, a shearing stress is applied to the recording layer 4.

Specifically, a black PET film (a resin film mixed with carbon black) with a thickness of 100 μm was set in the feed roll 110 as the base film 2a. A transparent PET film with a thickness of 3 μm was set in the feed roll 120 as the preventive film 5a.

A liquid crystal composition for the recording layer 4 contained low molecular weight cholesteric liquid crystalline compounds. Specifically, the liquid crystalline compounds expressed by the chemical formulas (A₁) and (B₁) were mixed with each other at the ratio by weight of 1:1, and spacer particles with an average diameter of 8 μm were added to the mixture.

The liquid crystal composition was filled in the dispenser section 113. Then, the dispenser section 113 was heated until the liquid crystal came to an isotropic phase. In this state, the liquid crystal composition was coated on the base film 2a by use of the coating roll 114. At this time, the liquid crystal composition was heated by the heating oven 115 so that the thickness of the liquid crystal composition coated on the base film 2a which was being fed in the direction of arrow “a” could be constant.

The base film 2a with the liquid crystal composition coated thereon and the protective film 5a fed from the feed roll 120 joined at a junction between the heat roller 131 and the nip roller 132, where the films 2a and 5a were heated and pressed against each other to turn into a laminate. This laminate was then fed into the tension applying device 150. In the device 150, while the laminate was passing between the tension rollers 152, 153 and 154, the laminate was supplied with a shearing stress and subjected to an alignment treatment.

Thereafter, the laminate was cooled and cut by the cutter 136 into pieces with specified dimensions, and the sides of each piece were sealed by UV setting resin. Thus, a sheet-like rewritable thermosensible recording medium 1D which had a recording layer 4 with a thickness of 8 μm was produced.

The operating temperature range of the recording medium 1D was from 55° C. to 120° C., and within this temperature range, the wavelengths of light reflected by the recording medium 1D varied from 680 nm to 400 nm. When writing was performed by a thermal head, the changeable range of reflected colors was wide, and good recording performance was achieved. The contrast between a green printed portion and a black portion was expressed as the ratio of 8:1 when the Y values (luminous reflectance) of these portions were compared with each other.

### Sixth Example of Recording Medium; See FIGS. 4, 8 and 13

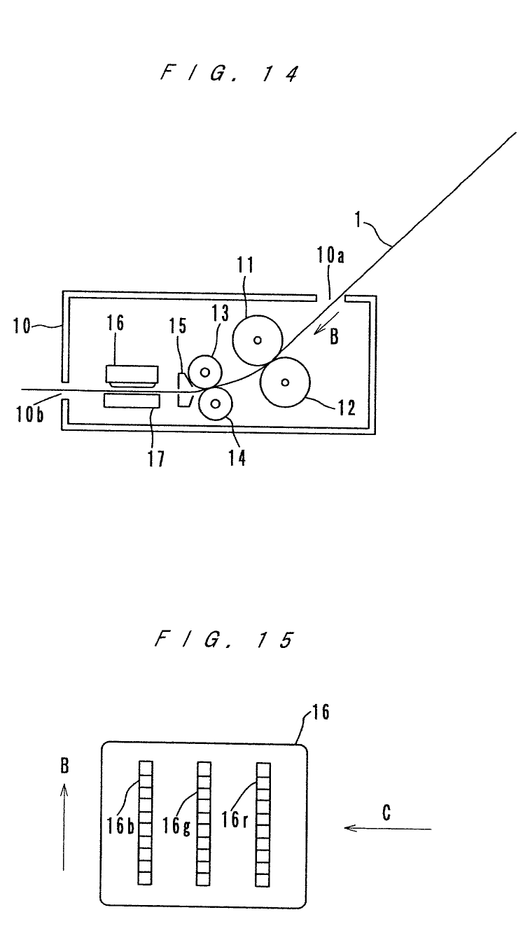

Another example of the rewritable thermosensible recording medium 1D is described referring to a producing method thereof. A manufacturing apparatus which was used to produce this example is basically of the same structure as the apparatus shown by FIG. 8; however, instead of the coating device 112, a coating device 160 shown by FIG. 13 is provided.

The coating device 160 comprises a cooling roll 161, feed rollers 162, 163 and 164 for feeding a base film 2a to the cooling roll 161, conveyer rollers 165 and 166 which peel the base film 2a from the cooling roll 161 and transports in the direction of arrow “a”, a dispenser section 167, a doctor roll 168 and a coating roll 169.

A black PET film (a resin film mixed with carbon black) with a thickness of 200 μm was set in the feed roll 110 as the base film 2a. A transparent PET film with a thickness of 3 μm was set in the feed roll 120 as the preventive film 5a. On the preventive film 5a, fixed type spacer particles, which are spacer particles coated with resin, with an average diameter of 10 μm were coated beforehand.

The base film 2a was fed from the feed roll 110 onto the cooling roll 161 via the rollers 162, 163 and 164 (see FIG. 13). The preventive film 5a was fed from the feed roll 120 to the heat roller 131 via the roller 121.

A liquid crystal composition for the recording layer 4 contained an intermediate molecular weight liquid crystalline compound. Specifically, the liquid crystalline compounds expressed by the chemical formulas (A₁) and (B₁) were mixed with each other at the ratio by weight of 1:1.

The liquid crystal composition was filled in the dispenser section 167 and melted. In this state, while the doctor roll 168 was regulating the amount of the liquid crystal composition flowing out, the liquid crystal composition was coated on the cooling roll 161 to be of an even thickness. The liquid crystal composition (liquid crystal layer) on the cooling roll 161 was bonded with the base film 2a by pressure applied from the roller 164. The bonded base film 2a and the liquid crystal layer were peeled from the cooling roll 161 supported by the roller 165 and transported to the nip roller 132 (see FIG. 8) via the roller 166.

The base film 2a with the liquid crystal layer thereon and the preventive film 5a were heated and pressed between the heat roller 131 and the nip roller 132 to be structured into a laminate. Thereafter, the laminate was supplied with a shearing stress by the tension rollers 133 and 134 and subjected to an alignment treatment.

Then, the laminate was cooled and cut by the cutter 136 into pieces with specified dimensions. Thus, a sheet-like rewritable thermosensible recording medium 1D which had a recording layer 4 with a thickness of 10 μm was produced.

The operating temperature range of the recording medium 1D was from 55° C. to 120° C., and within this temperature range, the wavelength of light selectively reflected by the recording medium 1D varied from 680 nm to 400 nm. When writing was performed by a thermal head, the changeable range of reflected colors was wide, and good recording performance was achieved. The contrast between a green printed portion and a black portion was expressed as the ratio of 7:1 when the Y values (luminous reflectance) of these portions were compared with each other.

### First Comparative Example

As a first comparative example, a recording medium which is of the same structure as the recording medium 1A shown by FIG. 1 was produced. For the base 2, the intermediate layer 3, and the preventive layer 5, the same materials which were used in the above-described first example were used.

As a liquid crystal composition, the liquid crystalline compounds expressed by the chemical formulas (A₁) and (B₁) were mixed with each other at the ratio by weight of 1:1, and tetrahydrofuran and this mixture were mixed and dissolved with each other at the ratio by weight of 10:1. This solution was coated on the intermediate layer 3 by a blade and was heated and dried to become a thickness of 10 μm. In this way, the recording layer 4 was formed. On the recording layer 4, a transparent PET film with a thickness of 6 μm was covered as the preventive film 5, and the sides were sealed by UV setting resin. No shearing stresses were applied to the recording layer 4.

The operating temperature range of this first comparative example was from 60° C. to 120° C., and within this temperature range, the wavelength of light selectively reflected by the recording medium 1D varied from 680 nm to 410 nm. When writing was performed by a thermal head, color unevenness occurred, and temperature control was difficult. The contrast between a green printed portion and a black portion was expressed as the ratio of 4:1 when the Y values (luminous reflectance) of these portions were compared with each other.

### Second Comparative Example

As a second comparative example, a recording medium which is of the same structure as the recording medium 1A shown by FIG. 1 was produced. For the base 2, the intermediate layer 3, and the preventive layer 5, the same materials which were used in the above-described first example were used.

As a liquid crystal composition, the liquid crystalline compounds expressed by the chemical formulas (A₁) and (B₁) were mixed with each other at the ratio by weight of 1:1, and spacer particles with an average diameter of 10 μm were added to the mixture. This liquid crystal composition was coated on the intermediate layer 3 by a blade while being heated. In this way, the recording layer 4 was formed. On the recording layer 4, a transparent PET film 5 with a thickness of 6 μm was covered as the preventive layer 5 and pressed by a roller while being heated. Thereafter, the laminate of the base 2, the intermediate layer 3, the recording layer 4 and the preventive layer 5 was cooled, and the sides were sealed by UV setting resin. No shearing stresses were applied to the recording layer 4.

The operating temperature range of this second comparative example was from 55° C. to 120° C., and within this temperature range, the wavelength of light selectively reflected by the recording medium 1D varied from 680 nm to 400 nm. When writing was performed by a thermal head, color unevenness occurred, and temperature control was difficult. The contrast between a green printed portion and a black portion was expressed as the ratio of 5:1 when the Y values (luminous reflectance) of these portions were compared with each other.

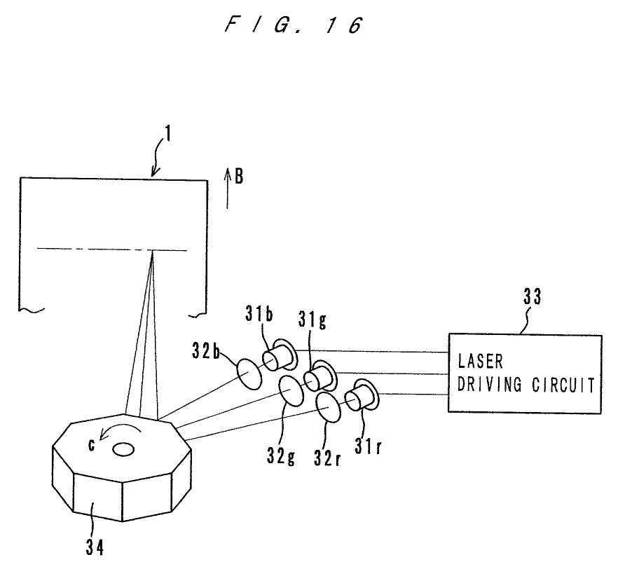

### Thermal Printer; See FIGS. 14 and 15

Next, a thermal printer for writing information on the recording media 1 (1A through 1G) is described. As FIG. 14 shows, the printer comprises, in a housing 10, along the traveling direction B of a recording medium 1, transport rollers 11 and 12, heat rollers 13 and 14, a cooler 15, a thermal head 16 and a platen 17.

A recording medium 1 enters the printer through an inlet 10a and is fed from the transport rollers 11 and 12 to the heat rollers 13 and 14. At the heat rollers 13 and 14, the recording medium 1 is heated over 120° C. and thereafter cooled rapidly by the cooler 15. By this process, information on the recording medium 1 is erased. Next, the recording medium 1 is fed between the platen 17 and the thermal head 16, where necessary information is written thereon. The recording medium 1 is heated by the thermal head 16 and comes to a display state. Then, after the application of heat from the thermal head 16 is stopped, the recording medium 1 is cooled rapidly, and thereby, the liquid crystal is solidified. Then, the recording medium 1 is ejected from the printer through an outlet 10b.

After passing by heating members of the thermal head 16, the recording medium 1 is naturally cooled rapidly, and therefore, no cooling means is necessary after the thermal head 16; however, in order to cool the recording medium 1 certainly, another cooler may be provided after the thermal head 16.

As FIG. 15 shows, the thermal head 16 has three heating members 16r, 16g and 16b which are jaxtaposed in a direction C which is perpendicular to the medium traveling direction B. The heating member 16r is to write in red; the heating member 16g is to write in green; and the heating member 16b is to write in blue. In each of the heating members, a large number of pixel components are arranged in the medium traveling direction B.

The thermal head 16 reciprocates in the direction C perpendicular to the medium traveling direction B in synchronization with the travel of a recording medium 1. Each of the heating members 16b, 16g and 16r, while moving in the direction C, turns on and off the pixel components in accordance with image data of each color. Thus, writing is performed on lines which correspond to the number of pixel components of each heating member while the thermal head 16 is moving from a side to the other side once. By repeating heating and non-heating in this way, finally, a full-color image is written on the recording medium 1.

Preferably, the order of colors to be written is from the one which necessitates the highest temperature to the one which necessitates the lowest temperature. Namely, it is preferred that the blue heating member 16b, the green heating member 16g and the red heating member 16r are operated in this order. It is possible to write information in three colors by use of a single heating member; in this case, however, temperature control is very complicated. Therefore, it is preferred that writing in three colors is performed by three heating members.

### Laser Printer; See FIG. 16

It is also possible to write information on the recording media 1 (1A through 1G) by use of a laser printer as shown by FIG. 16. In this case, it is preferred that an infrared-ray absorbent is added to the intermediate layer 3 and/or the preventive layer 5 so that the energy of a laser beam can be converted into heat. For the intermediate layer 3 and/or the preventive layer 5, materials with an infrared-ray absorbing characteristic may be used. If the intermediate layer 3 is not provided, a material with an infrared-ray absorbing characteristic may be used for the base 2.

In the laser printer shown by FIG. 16, lasers 31b, 31g and 31r, which are laser diodes, carbon oxide lasers, YAG lasers or the like, are modulated by a driving circuit 33, and laser beams emitted from the lasers 31b, 31g and 31r are incident to a polygon mirror 34 through collimator lenses 32b, 32g and 32r, respectively. The polygon mirror 34 is driven to rotate in the direction of arrow “c”, and with the rotation of the polygon mirror 34, the laser beams are deflected. The deflected laser beams scan linearly on a recording medium 1, and while the recording medium 1 is transported in the direction of arrow “B”, a two-dimensional full-color image is written.

Although not shown, the laser printer further comprises optical elements such as an fθ lens, etc.

The colors to be written by the lasers 31b, 31g and 31r are determined by the radiation energy of the lasers 31b, 31g and 31r. It is possible to use only one laser, and in this case, by controlling the radiation energy of the laser, the color to be written can be controlled. The energy control is easier when three lasers are used to write different colors.

### Other Embodiments

Various kinds of liquid crystalline compounds such as polymer cholesteric liquid crystal as well as the compounds expressed by the chemical formulas (A) through (G) can be used for the recording layer.

In the embodiments above, examples of producing sheet-like recording media by using long films as the materials were described. These long films may be wound up again after they are laminated together. Needless to say, it is possible to use film sheets to produce sheet-like recording media.

Although the present invention has been described with reference to the preferred embodiments above, it is to be noted that various changes and modifications are possible to those who are skilled in the art. Such changes and modifications are to be understood as being within the scope of the present invention.

What is claimed is:

1. A rewritable thermosensible recording medium comprising:
a base film of a polymeric material;
a recording layer which contains a liquid crystalline compound; and
a preventive film of a polymeric material;
wherein, the liquid crystalline compound contained in the recording layer has alignment which is controlled by application of a shearing stress which is attained by application of pressure under heat.

2. The rewritable thermosensible recording medium according to claim 1, wherein the liquid crystalline compound contained in the recording layer is a liquid crystalline compound which exhibits a cholesteric phase.

3. The rewritable thermosensible recording medium according to claim 1, comprising recording layers on an upper surface and on a lower surface of the base film.

4. The rewritable thermosensible recording medium according to claim 1, further comprising an intermediate layer between the base film and the recording layer, the intermediate layer having a smooth surface which is in contact with the recording layer.

5. The rewritable thermosensible recording medium according to claim 1, wherein the recording layer further contains an additive including at least a plasticizer.

6. The rewritable thermosensible recording medium according to claim 1, wherein the base film is a black film of a polymeric material.

7. The rewritable thermosensible recording medium according to claim 1, wherein the recording layer further contains a spacer.

8. The rewritable thermosensible recording medium according to claim 1, wherein the recording layer is a composite layer of the liquid crystalline compound and a polymeric material.

9. A method for producing a rewritable thermosensible recording medium, said method comprising the steps of:
placing a recording layer containing a liquid crystalline compound and a preventive film of a polymeric material on a base film of a polymeric material to structure these films and layer into a laminate; and
applying a shearing stress to the recording layer by applying pressure under heat.

10. The method according to claim 9, wherein by carrying out a bending treatment continuously toward the laminate of the base film, the recording layer and the preventive film, a shearing stress is applied to the recording layer.

11. The method according to claim 10, wherein the bending treatment is carried out by at least one freely rotating roller.

12. The method according to claim 10, by causing the laminate of the base film, the recording layer and the preventive film to pass between at least two freely rotating rollers continuously, a sharing stress is applied to the recording layer.

13. The method according to claim 9, wherein long films are used as the base film and the preventive film.

14. The method according to claim 13, further comprising, after the step of applying a shearing stress to the recording layer, a step of cutting the long films.
